(19) United States
(12) Patent Application Publication
(10) Pub. No.: US 2006/0232711 A1
(43) Pub. Date: Oct. 19, 2006

(54) Modified luminance weights for saturation control

(75) Inventor: Cornelis A.M. Jaspers, Hapert (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/568,476

(22) PCT Filed: Aug. 18, 2004
(86) PCT No.: PCT/IB04/51470

§ 371 Date: Feb. 15, 2006

Related U.S. Application Data
(60) Provisional application No. 60/495,932, filed on Aug. 18, 2003.

(51) Int. Cl. H04N 9/68

(52) U.S. Cl. 348/645

(57) ABSTRACT

The present invention is directed to method of processing a luminance signal including predetermined weights and color difference signals. In particular, the method includes the luminance signal and the color difference signals being converted into color signals. A second luminance signal is formed from the color signals. The second luminance signal includes second weights different from the predetermined weights. The second luminance signal is subtracted from each of the color signals to produce second color difference signals. The second color difference signals are amplified by a saturation parameter to produce amplified difference signals. Further, the second luminance signal is added to each of the amplified difference signals to produce output color signals.

The present invention relates generally to video signal processing, and more particularly, to a method of saturation control that changes luminance weights of a luminance signal in order to provide a more balanced color picture as the level of saturation control increases.

In 1953, the first color television system was developed in the United States, which was approved by the Federal Communications Commission (FCC) for broadcasting shortly thereafter. In order to make this system backward compatible with the existing monochrome system, video information was transmitted by a luminance signal and a chrominance signal. The luminance signal provided brightness information while the chrominance signal provided color information.

The luminance signal is derived from gamma-corrected red, green and blue signals as follows:
Y′=0.299R′+0.587G′+0.114B′ (1)

The chrominance signal is made up of color difference signals that are combined with the luminance signal to produce red, green and blue color signals that are used to produce a color picture on a display. These color difference signals specify the differences between the luminance signal and the gamma-corrected red, green and blue color signals as follows:
PB=0.492(B′−Y′)
PR=0.877(R′−Y′) (2)

Saturation control in color television is based on the amplification of the color difference signals with the luminance signal. As can be seen from Equation (1), the luminance signal has three predetermined weights (YR:YG:YB=0.299:0.587:0.114) that determine the contribution of each of the RGB color signals. These predetermined weights were defined according the FCC standardization of 1953. It should be noted that other color television systems such as the Phase Alternation line (PAL) use these same RGB weights.

A drawback with the present color systems is that at higher levels of saturation control the brightness of the color picture is not always balanced. This is because the above-described RGB weights in Equation (1) cause a relative exaggerated increase of the blue, red and magenta colors and a rather poor increase of the cyan and yellow colors as saturation control increases.

In view of the above, the present invention is directed to method of processing a luminance signal including predetermined weights and color difference signals. In particular, the method includes the luminance signal and the color difference signals being converted into color signals. A second luminance signal is formed from the color signals. The second luminance signal includes second weights different from the predetermined weights. The second luminance signal is subtracted from each of the color signals to produce second color difference signals. The second color difference signals are amplified by a saturation parameter to produce amplified difference signals. Further, the second luminance signal is added to each of the amplified difference signals to produce output color signals.

In one example, the output color signals may be stored. In another example, the output color signals may be displayed.

Referring now to the drawings were like reference numbers represent corresponding parts throughout:

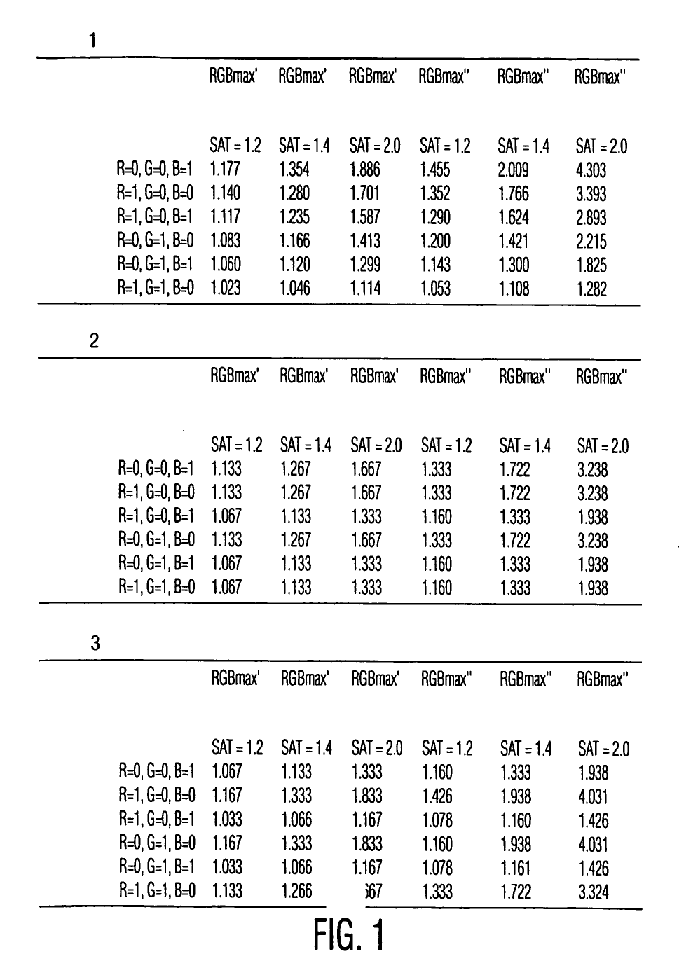

FIG. 1 is a diagram including tables comparing the saturation control using the FCC luminance weights and according to the present invention;

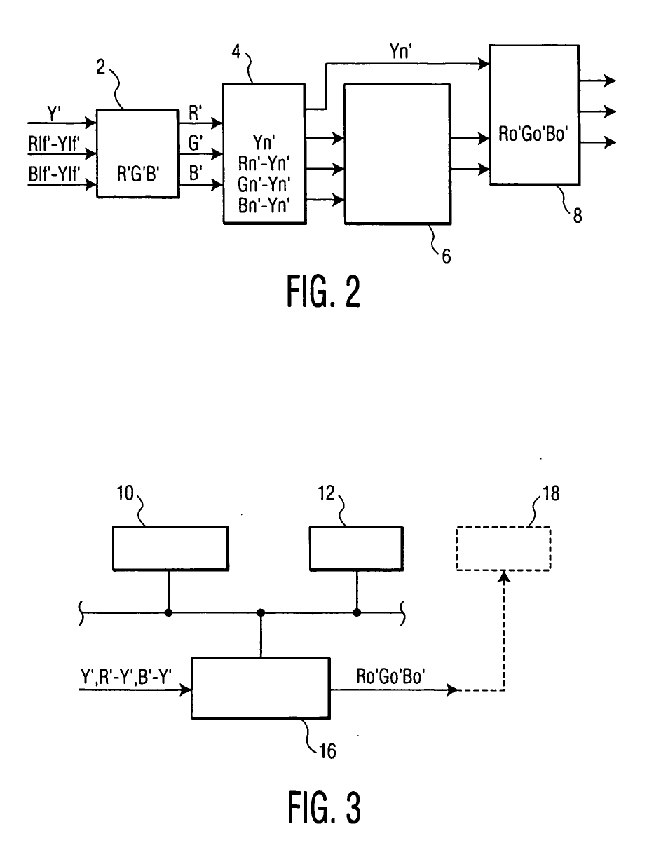

FIG. 2 is a diagram showing one example of saturation control according to the present invention; and

FIG. 3 is a diagram showing one example of a device according to the present invention.

As previously described, saturation control in color television systems is based on the amplification of the colour difference signals with a luminance signal having predetermined RGB contributions (YR:YG:YB=0.299:0.587:0.114) according to the FCC standardization of 1953. A drawback with these predetermined weights is that as color saturation increases, a relative exaggerated increase of blue, red and magenta colors occur. While a rather poor increase of cyan and yellow colors occur. However, according to the present invention, by modifying the predetermined weights of the luminance signal, the brightness of the yellow and cyan color is increased providing a more balanced color picture as saturation control increases.

In order to illustrate the saturation control according to the present invention, the effect on RGB signals before display and the relative light output of the maximum of the three RGB outputs after the display will be calculated for a number of different sets of luminance weights. These results are shown in the tables of FIG. 1. In Table 1, the RGB luminance weights will be according to the FCC standard, (YR:YG:YB=0.299:0.587:0.114). In Table 2, the RGB luminance contributions will be equal, (YR:YG:YB=0.333:0.333:0.333). In Table 3, there will be a high B-contribution, (YR:YG:YB=0.167:0.167:0.666).

The increase in the saturation control occurs in the nonlinear color difference signals after the camera gamma, as follows:
(R−Y)′=sat×(R′−Y′)
(B−Y)′=sat×(B′−Y′) (3)

After the saturation control, the RGB signals become:
R′=sat×(R′−Y′)+Y′
G′=sat×(G′−Y′)+Y′
B′=sat×(B′−Y′)+Y′ (4)

After a gamma (\tilde{α}) of 2.3 of the display, the relative R″G″B″ light output becomes:
R″=R′\tilde{α}, G″=G′\tilde{α}, B″=B′\tilde{α} (5)

The maximum of the RGBmax″ output of the display is:
RGBmax″=max{R″,G″,B″} (6)

In Tables 1-3, the increase of the relative RGBmax″ output is shown. The data in the tables has been calculated according Equation 4 for the relative RGBmax′ value after the saturation control and before the display. The relative RGBmax″ output of the CRT display has been calculated with Equation 6.

Depending on the maximum allowed saturation control by the television maker, the input signals before and after the display can be compared. For a LCD display, a saturation control of 1.2 is the acceptable maximum due to the limited reach of the LCD light output, then one can compare the columns with sat=1.2 in die three tables. For a CRT (or PDP) display, a higher amount of saturation control is allowed, then one can choose between the columns with sat=1.4 or sat=2.0. The latter will cause however a very exaggerated color reproduction.

The RGBmax″ output of the display represents the increase of the light output of the primary that has determined RGBmax″ according to Equation 6. As can be seen from Table 1, the FCC luminance weights causes a more exaggerated increase in the color blue at higher levels of saturation control. As can be seen from Table 2, the increase for the colors blue, red and green is the highest However, difference between the other colors cyan, yellow and magenta is much less at higher levels of saturation control. Therefore, a more balanced color picture is achieved at higher levels of saturation control.

As can be seen from Table 3, the increase for the colors red and green is the highest. Taken with the data in the other two tables, it can be determined that the primary color with the smallest luminance weight will cause the largest RGBmax″ increase at increasing levels of saturation control. Further, for the complementary color with the largest luminance weight will cause the smallest RGBmax″ at higher levels of saturation control.

It should also be noted that the use of more balanced luminance weights shift hue errors toward colors that the human eye is less sensitive too. This is because as saturation control increases the RGB color having the smallest luminance contribution will have the smallest hue error. In the FCC luminance weights, blue has the smallest contribution and thus will have the smallest hue error. While the opposite color yellow will have a larger hue error. Since the human eye is more sensitive to hue errors in yellow than in blue, this is a further disadvantage.

However, by using more balanced luminance weights such as in Table 2 of FIG. 1, the luminance contribution of the blue color causes a larger error in blue and a smaller in yellow. Since the human eye is less sensitive to hue errors in blue, the hue error can be reduced at higher saturation levels by modifying the FCC luminance weights.

One example of saturation control according to the present invention is shown in FIG. 2. As can be seen, a luminance signal Y′ and two color difference signals Rlf′−Ylf′, Blf′−Ylf′ are processed. As previously described, the luminance signal has predetermined weights (YR:YG:YB=0.299:0.587:0.114) according to the FCC standardization of 1953, which are also used in other color television systems such as PAL. Further, the two color difference signals are derived from the chrominance signal. In this example, the difference signals are in a low frequency form since these signals may be low pass filtered on the transmitter side.

In Step 2, the luminance signal Y′ and two color difference signals Rlf′−Ylf′, Blf′−Ylf′ are converted into color signals R′G′B′. The color signals R′G′B′ may be expressed as follows:
R′=(Rlf′−Ylf′)+(Ylf′+Yhf′)=Rlf′+Yhf′
G′=(Glf′−Ylf′)+(Ylf′+Yhf′)=Glf′+Yhf′
B′=(Blf′−Ylf′)+(Ylf′+Yhf′)=Blf′+Yhf′ (7)

In Step 4, a new luminance signal Yn′ is derived from the color signals R′G′B′ produced in Step 2. In order to derive the new luminance signal, each of the color signals R′G′B′ are multiplied by a weight that is different than the luminance coefficients as defined by the FCC standardization. According to the present invention, these different weights will be selected in order to provide a more balanced color picture at higher levels of saturation control. In particular, this will enable the yellow and cyan colors to be as bright as the other colors in the picture.

In one example, the luminance weights chosen will be equal such as (YR:YG:YB=0.333:0.333:0.333). However, it should be noted that the present invention is not limited to one set of weights. For example, the red signal weight YR and green signal weight YG weight may be chosen from the range of about 0.1 to about 0.4. Further, the blue signal weight YB may be chosen from the range of about 0.2 to about 0.8. The new luminance signal Yn′ may be expressed as follows:
Yn′=a×(Rlf′+Yhf′)+b×(Glf′+Yhf′)+c×(Blf′+Yhf′), (8)

where a, b and c are the different luminance weights and the color signals R′G′B′ are defined by Equation 7.

Further, Yn′ can be rewritten as:
Yn′=(a×Rlf′+b×Glf′c×Blf′)+Yhf′=Ynlf′+Yhf′, (9)

where Ynlf′=(a×Rlf′+b×Glf′c×Blf′).

In Step 4, three new color difference signals are also formed using the new luminance signal Yn′. These new color difference signals are formed by subtracting the new luminance signal Yn′ from each of the color signals R′G′B′ produced in Step 2. The three color difference signals may be expressed as follows:
Rn′−Yn′=(Rlf′+Yhf′)−Yn′
Gn′−Yn′=(Glf′+Yhf′)−Yn′
Bn′−Yn′=(Blf′+Yhf′)−Yn′ (10)

In Step 6, saturation control is performed on each of the color difference signals produced in step 4. In performing this step, each of the color difference signals is amplified by a saturation parameter. The saturation parameter is usually a value equal or grater than one (1) that may vary according to the characteristics of the display device or due to user preference. Further, the saturation parameter may be predetermined or may be dynamically changed during operation.

In Step 8, the amplified difference signals from Step 6 are then converted to output color signals Ro′ Go′ Bo′. These output color signals Ro′ Go′ Bo′ can either be stored or sent to a display device to produce a color picture. The output color signals Ro′ Go′ Bo′ are produced by adding the new luminance signal Yn′ to each of the amplified difference signals. The output color signals Ro′Go′Bo′ may be expressed as follows:
Ro′=sat×(Rn′−Yn′)+Yn′
Go′=sat×(Gn′−Yn′)+Yn′
Bo′=sat×(Bn′−Yn′)+Yn′, (11)

where sat is the saturation parameter.

By substituting Equation 10 into Equation 11, the output color signals Ro′Go′Bo′ become:
Ro′=sat×((Rlf′+Yhf′)−Yn′)+Yn′=sat×(Rlf′+Yhf′)+(1−sat)×Yn′
Go′=sat×((Glf′+Yhf′)−Yn′)+Yn′=sat×(Glf′+Yhf′)+(1−sat)×Yn′
Bo′=sat×((Blf′+Yhf′)−Yn′)+Yn′=sat×(Blf′+Yhf′)+(1−sat)×Yn′, (12)

which can be further rewritten by substituting Equation 9 into Equation 12 as follows:
Ro′=sat×(Rlf′+Yhf′)+(1−sat)×Ynlf′+(1−sat)×Yhf′)=sat×Rlf′+(1−sat)×Ynlf′+Yhf′)
Go′=sat×(Rlf′+Yhf′)+(1−sat)×Ynlf′+(1−sat)×Yhf′)=sat×Rlf′+(1−sat)×Ynlf′+Yhf′)
Bo′=sat×(Rlf′+Yhf′)+(1−sat)×Ynlf′+(1−sat)×Yhf′)=sat×Rlf′+(1-sat)×Ynlf′+Yhf′) (13)

In case the method of FIG. 2 is performed on signals with a full bandwidth such as Y′, (R′-Y′) and (B′-Y′), the output of Step 2 becomes:
R′=(R′−Y′)+Y′
G′=(G′−Y′)+Y′
B′=(B′−Y′)+Y′ (14)

Further, the new luminance signal Yn′ produced in Step 4 becomes:
Yn′=a×R′+b×G′+c×B′ (15)

After performing Steps 6 and 8, the output color signals Ro′Go′Bo′ become:
Ro′=sat×(R′−Yn′)+Yn′
Go′=sat×(G′−Yn′)+Yn′
Bo′=sat×(B′−Yn′)+Yn′ (16)

One example of a device according to the present invention is shown in FIG. 3. By way of example, the device may represent a television, a set-top box, a personal computer, a printer or an optical recording device such as a digital video recorder or a DVD as well as portions or combinations of these and other devices. The device includes a processor 10, memory 12, a bus 14 and one or more input/output devices 16. In case of the device being a television or a computer, it would also include a display 18.

The input/output devices 16, processor 10 and memory 12 communicate over the bus 14. Input signals including a luminance signal Y′ and color difference signals R′−Y′, B′−Y′ are processed in accordance with one or more software programs stored in memory 12 and executed by processor 10 in order to generate output color signals Ro′ Go′ Bo′. These output color signals Ro′ Go′ Bo′ can either be stored in the memory 12 or sent to the display 18 to produce a color picture.

In particular, the software programs stored in memory 12 includes the saturation control method of FIG. 2. In this embodiment, the saturation control method is implemented by computer readable code executed by the processor 10. Further, the code is stored in the memory 12. In other embodiments, hardware circuitry may be used in place of, or in combination with, software instructions to implement the invention.

While the present invention has been described above in terms of specific examples, it is to be understood that the invention is not intended to be confined or limited to the examples disclosed herein. Therefore, the present invention is intended to cover various structures and modifications thereof included within the spirit and scope of the appended claims.

1. A method of processing a luminance signal including predetermined weights and color difference signals, comprising the steps of:
converting the luminance signal and the color difference signals into color signals (2);
forming a second luminance signal from the color signals, wherein the second luminance signal includes second weights different from the predetermined weights (4);
subtracting the second luminance signal from each of the color signals to produce second color difference signals (4);
amplifying the second color difference signals by a saturation parameter to produce amplified difference signals (6); and
adding the second luminance signal to each of the amplified difference signals to produce output color signals (8).

2. The method of claim 1, which further includes displaying the output color signals.

3. The method of claim 1, which further includes storing the output color signals.

4. The method of claim 1, wherein converting the luminance signal and the color difference signals into color signals (2) is performed according to the following:
R′=Rlf′+Yhf′
G′=Glf′+Yhf′
B′=Blf′+Yhf′.

5. The method of claim 1, wherein converting the luminance signal and the color difference signals into color signals (2) is performed according to the following:
R′=(R′−Y′)+Y′
G′=(G′−Y′)+Y′
B′=(B′−Y′)+Y′.

6. The method of claim 1, wherein the second weights include:
a red signal weight in the range of about 0.1 to about 0.4;
a green signal weight in the range of about 0.1 to about 0.4; and
a blue signal weight in the range of about 0.2 to about 0.8.

7. The method of claim 1, wherein the saturation parameter is a value equal or greater than one (1).

8. A device for processing a luminance signal including predetermined weights and color difference signals, comprising:
means for converting the luminance signal and the color difference signals into color signals (2);
means for forming a second luminance signal from the color signals, wherein the second luminance signal includes second weights different from the predetermined weights (4);
means for subtracting the second luminance signal from each of the color signals to produce second color difference signals (4);
means for amplifying the second color difference signals by a saturation parameter to produce amplified difference signals (6); and
means for adding the second luminance signal to each of the amplified difference signals to produce output color signals (8).

9. The device of claim 8, which further includes means for displaying (18) the output color signals.

10. The device of claim 8, which further includes means for storing (12) the output color signals.

11. The device of claim 8, wherein the second weights include:
a red signal weight in the range of about 0.1 to about 0.4;
a green signal weight in the range of about 0.1 to about 0.4; and
a blue signal weight in the range of about 0.2 to about 0.8.

12. The device of claim 8, wherein the saturation parameter is a value equal or greater than one (1).

13. A memory medium including code for processing a luminance signal including predetermined weights and color difference signals, the code comprising:
a code for converting the luminance signal and the color difference signals into color signals (2);
a code for forming a second luminance signal from the color signals, wherein the second luminance signal includes second weights different from the predetermined weights (4);
a code for subtracting the second luminance signal from each of the color signals to produce second color difference signals (4);
a code for amplifying the second color difference signals by a saturation parameter to produce amplified difference signals (6); and
a code for adding the second luminance signal to each of the amplified difference signals to produce output color signals (8).

14. The memory medium of claim 13, wherein the second weights include:
a red signal weight in the range of about 0.1 to about 0.4;
a green signal weight in the range of about 0.1 to about 0.4; and
a blue signal weight in the range of about 0.2 to about 0.8.

15. The memory medium of claim 13, wherein the saturation parameter is a value equal or greater than one (1).

16. The memory medium of claim 13, which further includes a code for displaying the output color signals.

17. The memory medium of claim 13, which further includes a code for storing the output color signals.
